(19) United States
(12) Patent Application Publication
(10) Pub. No.: US 2012/0026423 A1
(43) Pub. Date: Feb. 2, 2012

(54) EDGE-LIT BACKLIGHT MODULE AND LCD USING THE SAME

(75) Inventors: Chengming He, Guangdong (CN); Yicheng Kuo, Guangdong (CN); Jie Ren, Guangdong (CN)

(73) Assignee: SHENZHEN CHINA STAR OPTOELECTRONICS TECHNOLOGY CO., LTD., Shenzhen (CN)

(21) Appl. No.: 12/995,737

(22) PCT Filed: Sep. 2, 2010
(86) PCT No.: PCT/CN10/76554

§ 371 Date: Dec. 2, 2010

(30) Foreign Application Priority Data
Jul. 30, 2010 (CN) 201010245778.0

(51) Int. Cl. G02F 1/1335; F21V 7/22

(52) U.S. Cl. 349/62; 362/613; 362/606

(57) ABSTRACT

The present invention discloses an edge-lit backlight module and a liquid crystal display using the same, which can achieve good local dimming. The edge-lit backlight module includes a light guide plate, which is divided into several sections disposed as a ladder shape. By disposing the light guide plate sections jointed with each other at different levels, a space is defined at a side edge of each section to dispose a light source such as an LED light bar, thereby realizing local dimming for multiple sections with edge-lit illumination.

### TECHNICAL FIELD OF THE INVENTION

The present invention relates to a liquid crystal displaying technique, more particularly, to an edge-lit backlight module for a liquid crystal display (LCD), which is able to realize good local dimming, and to an LCD using such an edge-lit backlight module.

### BACKGROUND OF THE INVENTION

Nowadays, liquid crystal displays (LCDs) are becoming the main stream of displaying technique, and are being widely applied to various electronic products such as a mobile phone, a PDA, a digital camera, a computer screen, a notebook screen and the like. A backlight module is one of the crucial components being a deciding factor of the quality of the LCD. Generally, the illuminating light source of the backlight module is implemented by an electro-luminance (EL) element, a light emitting diode, or a cold cathode fluorescent lamp. Among the above three light sources, LEDs are widely utilized in small LCD devices due to the small volume, light weight and excellent controllability.

LED backlight modules can be classified into types of direct-lit backlight modules and edge-lit backlight modules according to the disposal of the light sources thereof. In a direct-lit backlight module, LED dice are evenly disposed under a liquid crystal panel and server as the light source, thereby uniformly transmitting the backlight all over the screen.

FIG. 1 is a schematic diagram showing an application example of a conventional direct-lit LED backlight module. For sake of simplification and clarity, some components are omitted in the drawings. As shown, in an LCD, a light source constituted by an LED matrix 20 is disposed under a liquid crystal glass 10. The LED matrix 20 comprises a number of LED dice 201 arranged in columns and rows. The liquid crystal glass 10 comprises liquid crystal being sandwiched therein. The liquid crystal glass has been used in various applications. Since it is not the focus of the present invention, the details thereof are omitted herein.

In such a structure, the LED dice 201 are arranged under the liquid crystal glass 10 to provide the liquid crystal glass 10 with illumination light. Accordingly, local dimming can be easily realized. In this example, the liquid crystal glass 10 is divided into regions A1 to A6, B1 to B6, C1 to C6 and D1 to D6. By controlling the LED dice corresponding to the respective regions, the local dimming of each region can be achieved. The LED matrix 20 can transfer the heat thereof directly to a back plate (not shown) to accomplish heat dissipation. However, a great quantity of the LED dice is necessary for such a structure, and more electrical power is consumed thereof. Furthermore, the finished LCD will have a greater thickness since there is a layer of the LED matrix 20.

FIG. 2 is a schematic diagram showing an application example of a conventional edge-lit LED backlight module. As shown, LED light bars 22, 24 are disposed at the two long sides of a liquid crystal glass 11 respectively. Taking the LED light bar 24 as an example, the LED light bar 24 comprises a plurality of LED dice 241. In this example, the LED light bar 22 is used to control the luminance of each of the regions A1 to A6 of the liquid crystal glass 11; the LED light bar 24 is used to control the luminance of each of the regions B1 to B6 of the liquid crystal glass 11. The edge-lit LED backlight module requires fewer LED dice. However, the number of regions of the edge-lit backlight module in which the local dimming can be realized is considerably less than that of the direct-lit backlight module shown in FIG. 1 since only the LED light bars 22, 24 which are disposed at the two sides of the liquid crystal glass 11 are used for illumination and the illuminating range of each LED die is limited.

Therefore, an improved backlight module is required to solve the existing problems of the current technique.

### SUMMARY OF THE INVENTION

A main objective of the present invention is to provide an edge-lit backlight module, which can achieve local dimming for multiple regions with limited power consumption.

Another objective of the present invention is to provide a liquid crystal display (LCD) comprising an edge-lit backlight module, which can achieve local dimming for multiple regions with limited power consumption.

To achieve the foregoing objectives, the present invention provides an edge-lit backlight module. The edge-lit backlight module comprises a light guide plate divided into several sections, the light guide plate, which is composed of the sections, is formed as a ladder shape so that each section has a side edge exposed; and a plurality of light sources, each of the light sources is disposed at the exposed side edge of one of the sections of the light guide plate for illuminating the section.

In accordance with the present invention, in an embodiment, each of the top surface and the bottom surface of the light guide plate, which is composed of sections, is formed as a ladder shape, and two adjacent sections are jointed with each other in different levels to partially overlap.

In another embodiment, one of the top surface and the bottom surface of the light guide plate, which is composed of sections, is formed as a ladder shape and the other surface is flat so that each section has a side edge exposed. One of two adjacent sections of the light guide plate has a slot at the side edge for engaging with the other one section, while the remaining portion of the side edge is exposed, and the reserved thickness of the exposed portion of the side edge is able to define a space which is sufficient for disposing the light source.

In accordance with the present invention, in the edge-lit backlight module, the overlapping portions of the adjacent sections and also the adjacent sections of the light guide plate can be separated by setting a reflective layer.

In accordance with the present invention, the light sources in the edge-lit backlight module are implemented by LED light bars.

To achieve the above objectives, the present invention provides a liquid crystal display comprising a liquid crystal panel and the edge-lit backlight module described above.

The liquid crystal display further comprises a back plate, which is formed as ladder-like to be adaptable for receiving the light guide plate and the light sources.

To make the present invention more manifest and understandable, preferred embodiments will be described in detail in conjunction with the appending drawings:

### BRIEF DESCRIPTION OF THE DRAWINGS

FIG. 1 is a schematic diagram showing an application example of a conventional direct-lit LED backlight module.

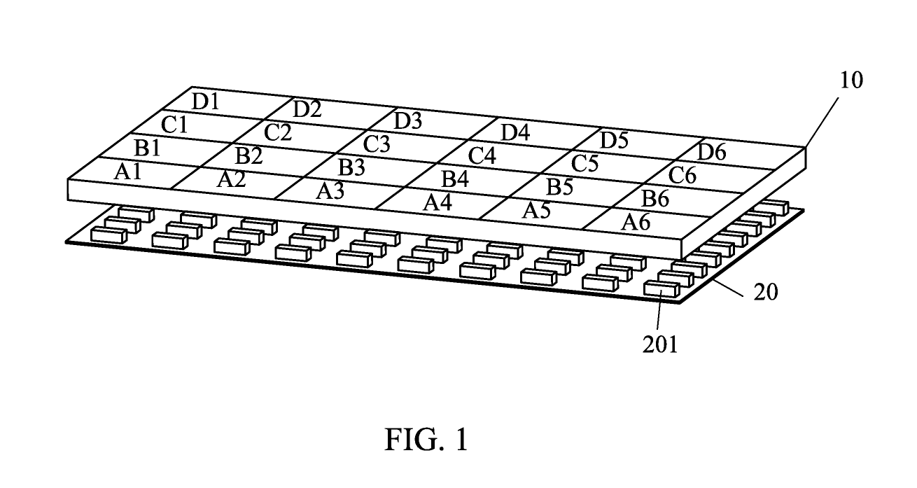

FIG. 2 is a schematic diagram showing an application example of a conventional edge-lit LED backlight module.

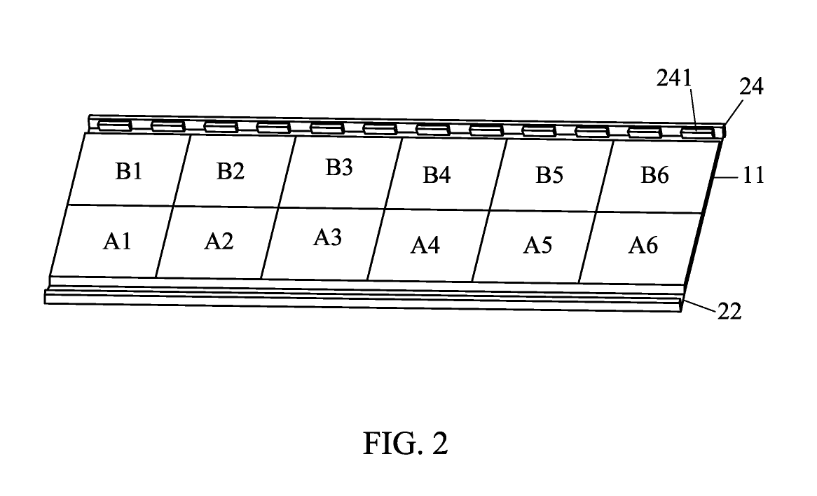

FIG. 3 is a schematic diagram showing a perspective view of an edge-lit backlight module in accordance with a first embodiment of the present invention.

FIG. 4 is a schematic diagram showing a sectional view of the edge-lit backlight module of FIG. 3.

FIG. 5 is a schematic diagram showing a sectional view of an edge-lit backlight module in accordance with a second embodiment of the present invention.

FIG. 6 is a schematic diagram of a perspective view showing the edge-lit backlight module in combination with a back plate of an LCD in accordance with the present invention.

FIG. 7 is a schematic diagram showing a sectional view of an edge-lit backlight module in accordance with a third embodiment of the present invention.

### DETAILED DESCRIPTION OF THE INVENTION

To make the forgoing objectives, features, and advantages more manifest and understandable, preferred embodiments of the present invention will be described in detail in conjunction with the appending drawings. Further, the directional terms described in the present invention such as “above”, “under”, “front”, “rear”, “left”, “right”, “internal”, “external”, “side”, “bottom”, “top” or the like only indicate the directions with reference to the drawings. Thus, those directional terms are only used for describing and understanding the present invention rather than limiting the scope of the present invention.

Generally speaking, a liquid crystal display (LCD) comprises at least a liquid crystal panel (e.g. a liquid crystal glass) and a backlight module. The backlight module is utilized for illuminating the liquid crystal panel. The backlight module usually comprises a light source or light sources, a light guide plate and other optical films such as a reflector film, a diffuser film, a polarizer film and the like. The light guide plate is generally made of transparent material such as optical PMMA (Polymethyl Methacrylate). The light guide plate is used to scatter the light from the light source(s) all over the displaying panel of the LCD. The above structure can be disposed on a back plate of the LCD. In the present invention, the light guide plate is designed to have a specific geometrical structure and the light sources are adaptively disposed so as to achieve the effect of local dimming for multiple regions without significantly increasing power consumption.

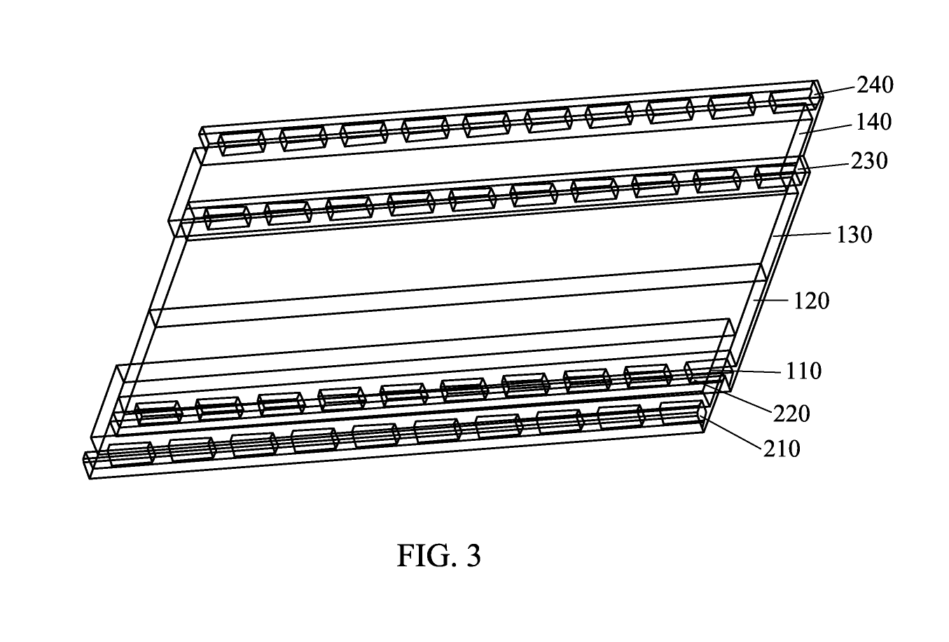

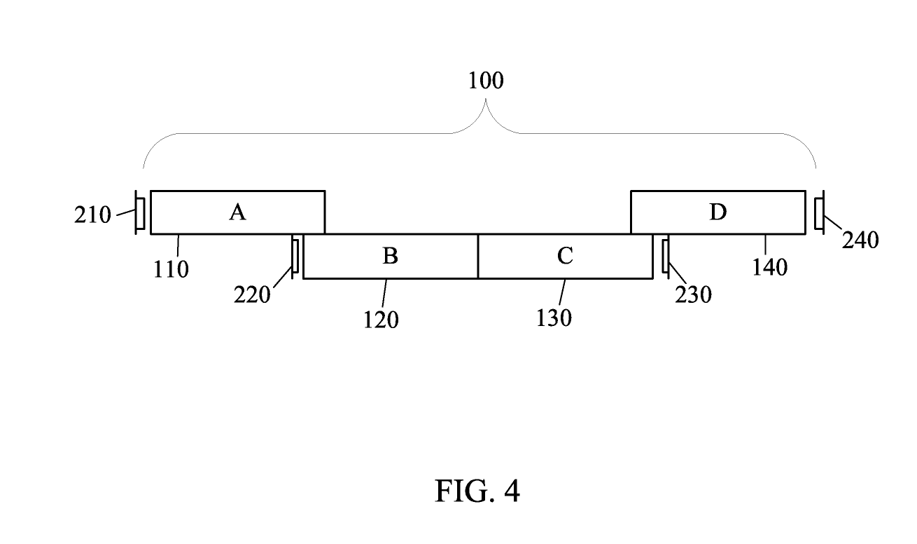

Please refer to FIG. 3 and FIG. 4. FIG. 3 is a schematic diagram showing a perspective view of an edge-lit backlight module in accordance with a first embodiment of the present invention, and FIG. 4 is a schematic diagram showing a sectional view of this edge-lit backlight module. According to the present invention, a light guide plate (LGP) 100 is divided into several sections such as the four sections: Section A 110, Section B 120, Section C 130 and Section D 140 shown in the drawings. Distinguishable from a conventional LGP, those LGP sections 110 to 140 are not disposed on the same plane. At least two adjacent sections are disposed at different levels to form a ladder shape. For example, Section A 110 and Section B120 form a ladder shape. Section A is at the higher level while Section B 120 is at the lower level. Section C 130 and Section D 140 also form a ladder shape. Section D 140 is at the higher level while Section C 130 is at the lower level. In the present embodiment, the adjacent Section B 120 and Section C 130 are disposed side by side on the same plane.

According to the present invention, the sections of the LGP 100 are disposed at different levels, so that it is possible to dispose a light source at a side edge of each section. As shown in the drawings, a bar-like light source (e.g. an LED light bar 210) is disposed at a side edge of Section A 110. Section B 120 is disposed at a level different from Section A 110, and therefore a space is made at the side edge of Section B to dispose the light bar such as an LED light bar 220. Similarly, an LED light bar 240 is disposed at a side edge of Section D 140. Section C 130 and Section D 140 are disposed at different levels so that a space is made at a side edge of Section C 130 to dispose an LED light bar 230.

The width of each of the sections: Section A 110, Section B 120, Section C 130 and Section D 140 is relative to the illuminating range of each light source (i.e. the light bars 210, 220, 230, 240).

By dividing the LGP into several sections and disposing the sections at different levels to form a ladder shape, spaces are created beside the side edges of the sections to install the light bars such as LED light bars. The local dimming of each section is achieved by controlling the corresponding light source. Therefore, a backlight module with a large area can be produced and excellent local dimming can be accomplished at the same time. Furthermore, in comparison with the conventional direct-lit backlight module, the edge-lit backlight module in accordance with the present invention does not need to use so many light source elements (e.g. LED dice), and accordingly the power consumption can be reduced.

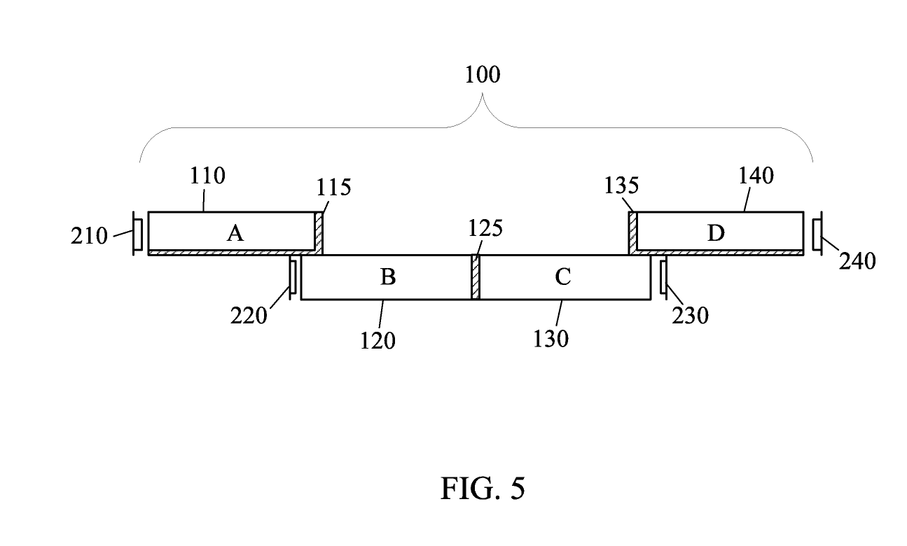

FIG. 5 is a schematic diagram showing a sectional view of an edge-lit backlight module in accordance with a second embodiment of the present invention, in which the same reference numbers indicate the same components. As in the previous embodiment, the LGP 100 is composed of four sections: Section A 110, Section B 120, Section C 130, Section D 140, in which Section A 110 is adjacent to Section B 120, and Section A 110 is at the higher level while Section B 120 is at the lower level; Section B is adjacent to and joined with Section C 130 and is located at the same level (the lower level) with Section C 130; Section C 130 is adjacent to and joined with Section D 140, and Section C 130 is located at the lower level while Section D 140 is located at the higher level; and Section D 140 is at the same level (the higher level) with Section A 110.

As shown, in order to have the LGP 100 keep a certain degree of strength, Section B 120 and Section A 100 partially overlap at the joint to form an overlapping portion. In this overlapping portion, in addition to the corresponding LED light bar 220, Section B 120 is also influenced by the LED light bar 210 corresponding to Section A 110. This is because the illuminating range of the LED light bar 210 extends to the end of Section A 100, that is, the portion overlapped by Section B 120. Similarly, the portion of Section A 110, which is overlapped by Section B 120, in addition to the corresponding LED light bar 210, is also influenced by the LED light bar 220 corresponding to Section B. Therefore, a phenomenon referred to as “clutter” occurs.

To prevent the light of the corresponding light source for Section B 120 (i.e. the LED light bar 220) from entering into Section A 110, and in the meanwhile prevent the light of the corresponding light source for Section A 110 (i.e. the LED light bar 210) from entering into Section B 120, in the present embodiment, a reflective layer 115 is provided at the bottom of Section A 110 and also at the side of one end of Section A 110 which is opposite to the end near the LED light bar 210 (i.e. the end located at the overlapping portion) to separate Section A 110 from Section B 120 at the overlapping portion. Similarly, a reflective layer 135 is provided on the bottom of Section D 140 and also at the side of an end of Section D 140 in the overlapping portion. At the overlapping portion, Section A 110 is separated from Section B by using the reflective layer 115. Similarly, at the overlapping portion, Section C 130 is separated from Section D 140 by using the reflective layer 135. A reflective layer 125 is provided at the junction between Section B 120 and Section C 130 to separate these two sections, thereby avoiding interference of the lights from the respective light sources corresponding to these sections. Accordingly, Section A 110, Section B 120, Section C 130 and Section D 140 form a continuous planar light source jointly, and each of the sections can be controlled individually and independently.

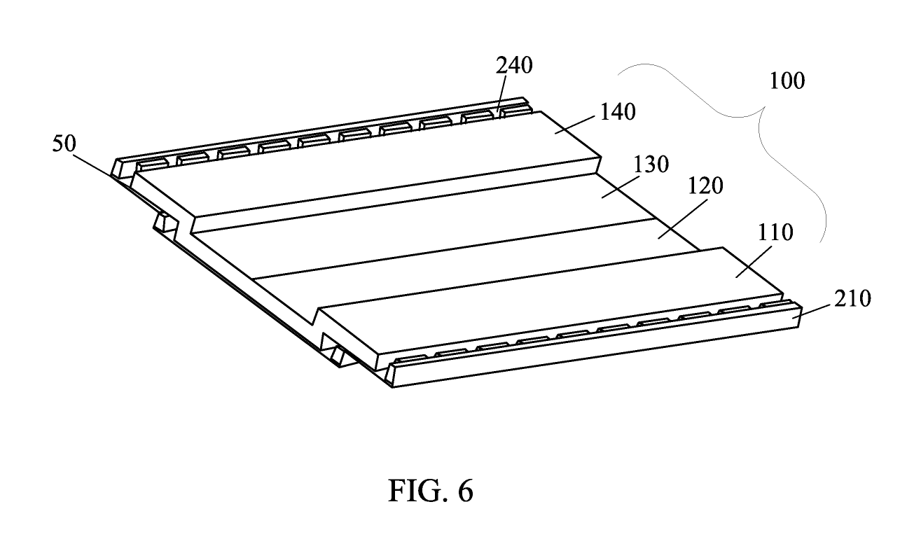

For enhancing the firmness and structural stability of the whole edge-lit backlight module, a back plate of an LCD (not shown) can be formed a specific shape according to the bottom profile of the ladder-like LGP 100 of the edge-lit backlight module in the present invention. The back plate secures the LGP 100 in coordination with a mold frame (not shown), as shown in FIG. 6, which is a schematic diagram of a perspective view showing the edge-lit backlight module in combination with the back plate of an LCD in accordance with the present invention. As shown, the back plate 50 of the LCD is formed as a ladder shape and defines a ladder-like receiving tray, which is suitable for receiving the ladder-like LGP 100 as well as the LED light bars 210 to 240 disposed at the side edges of the respective sections 110 to 140.

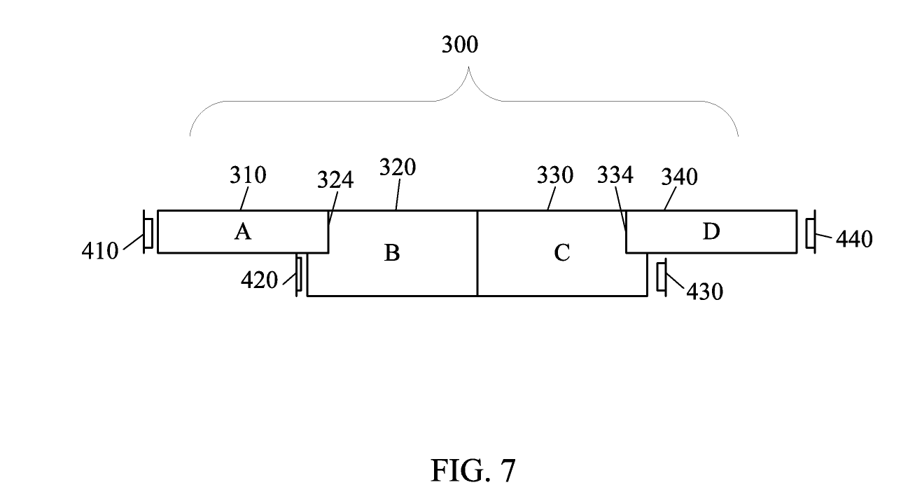

FIG. 7 is a schematic diagram showing a sectional view of an edge-lit backlight module in accordance with a third embodiment of the present invention. In the present embodiment, the backlight module comprises a light guide plate (LGP) 300. The LGP 300 comprises four sections: Section A 310, Section B 320, Section C 330 and Section D 340 and LED light bars 410, 420, 430 and 440 are disposed at the side edges of these sections, respectively. The difference between the present embodiment and the previous embodiments is that the shapes of the intermediate Section B 320 and Section C 330 are changed and cease to be simply rectangular as the previous embodiments.

As shown, in the present embodiment, Section B 320 is thicker and has a recess 324 at the left side edge for engaging with Section A 320. After engaging with each other, the top surfaces of Section A 310 and Section B 320 are flat. In addition, the bottom surfaces of Section A 310 and Section B 320 form a ladder shape since these two sections have different thicknesses. A portion of the side edge below the recess 324 of Section B 320 is exposed. The reserved thickness below the recess 324 at the side edge of Section B is sufficient to dispose an LED light bar 420 at the left side edge of Section B 320 and in the meanwhile under Section A 310 to illuminate Section B.

Similarly, Section C 320 is thicker than Section D 340 and has a recess 334 at a side edge (i.e. the right side edge shown in the drawing) to engage with Section D 340. After engaging with each other, the top surfaces of Section D 340 and Section C 330 are flat. In addition, the bottom surfaces of Section D 340 and Section C 330 form a ladder shape since these two sections have different thicknesses. A portion of the side edge (i.e. the right side edge shown in the drawing) below the recess 334 of Section C 330 is exposed. The reserved thickness below the recess 334 at the side edge of Section C is sufficient to dispose an LED light bar 430 at the right side edge of Section C 330 and in the meanwhile under Section D 340 to illuminate Section C. Section B 320 and Section C 330 have the same thickness and are shaped in mirror image symmetry.

Such a structure makes the LGP 300 firmer and easier to be secured. It is noted that the top surface of the LGP 300 described above is flat and the bottom surface is ladder-like. However, quite contrary, that is, it is also practicable that the top surface is ladder-like and the bottom surface is flat. In addition, the four LGP sections can be formed integrally. Further, as the previous embodiment, a reflective layer can be applied between two adjacent sections at the overlapping portion to avoid clutter phenomenon. The manner of implementation is similar to the previous embodiment, and therefore the description thereof is omitted herein.

As shown, in the present embodiment, the top surface of the LGP 300 of the edge-lit backlight module is flat, just as a general LGP, while the bottom surface thereof is ladder-like, by forming the LGP 300 such a specific shape, spaces are created to dispose the LED light bars 420 and 430 for illuminating Section B 320 and Section C 330, respectively.

It is noted that the respective embodiments described above each comprises four sections, however, the present invention is not limited thereto. For example, the edge-lit backlight module LGP in accordance with the present invention may comprise three sections or more than four sections.

From the foregoing, while the present invention has been disclosed by describing the preferred embodiments, various modifications and alterations can be made by persons skilled in this art without departing from the spirit and realm of the present invention, and therefore the claimed scopes of the present invention to be protected should be according to the scopes defined in the appended claims.

What is claimed is:

1. A liquid crystal display comprising a liquid crystal panel and a backlight module, characterized in that: said backlight module comprising:
a light guide plate divided into a plurality of sections, the light guide plate, which is composed of said sections, being formed as a ladder shape to expose a side edge of each section; and
a plurality of light sources, each disposed at the exposed side edge of one of said sections for illuminating said one of the sections;
wherein a top surface or a bottom surface of the light guide plate composed of said sections is ladder-like, and the other surface is flat so as to expose a side edge of each section; and one of two adjacent sections of said sections of the light guide plate has a recess at said side edge for engaging with the other sections, and a residual portion of said side edge is exposed; a reserved thickness of the exposed portion of the side edge defines a space to dispose said light source; and said liquid crystal display further comprises a back plate, said back plate constructed as ladder-like to receive said light guide plate and said light sources.

2. An edge-lit backlight module for a liquid crystal display, characterized in that: said backlight module comprises:
a light guide plate divided into a plurality of sections, the light guide plate, which is composed of said sections, being formed as a ladder shape exposing a side edge of each section; and
a plurality of light sources, each disposed at the exposed side edge of one of said sections for illuminating said one section.

3. The edge-lit backlight module according to claim 2, characterized in that: two adjacent sections among said sections are disposed to join with each other at different levels to form a ladder shape.

4. The edge-lit backlight module according to claim 3, characterized in that: two adjacent sections among said sections are disposed side by side on the same plane.

5. The edge-lit backlight module according to claim 4, characterized in that: said light guide plate further comprises a reflective layer at a junction of the two sections disposed side by side to separate the sections.

6. The edge-lit backlight module according to claim 3, characterized in that: the two adjacent sections disposed at different levels partially overlap with each other to form an overlapping portion, said light guide plate further comprises a reflective layer for separating said two adjacent sections at the overlapping portion.

7. The edge-lit backlight module according to claim 2, characterized in that: a top surface or a bottom surface of the light guide plate composed of said sections is ladder-like while the other surface is flat so as to expose a side edge of each section.

8. The edge-lit backlight module according to claim 7, characterized in that: one of two adjacent sections of said sections of the light guide plate has a recess at the side edge for engaging with the other section, and a residual portion of said side edge is exposed.

9. The edge-lit backlight module according to claim 8, characterized in that: the exposed portion of said side edge reserves a thickness for defining a space to dispose the light source.

10. A liquid crystal display comprising a liquid crystal panel and a backlight module, characterized in that: said backlight module comprises:
a light guide plate divided into a plurality of sections, the light guide plate, which is composed of said sections, being formed as a ladder shape exposing a side edge of each section; and
a plurality of light sources, each disposed at the exposed side edge of one of said sections for illuminating said one section.

11. The liquid crystal display according to claim 10, characterized in that: two adjacent sections among said sections are disposed to join with each other at different levels to form a ladder shape.

12. The liquid crystal display according to claim 11, characterized in that: two adjacent sections among said sections are disposed side by side on the same plane.

13. The liquid crystal display according to claim 12, characterized in that: said light guide plate further comprises a reflective layer at a junction of the two sections disposed side by side to separate the sections.

14. The liquid crystal display according to claim 11, characterized in that: the two adjacent sections disposed at different levels partially overlap with each other forming an overlapping portion, said light guide plate further comprises a reflective layer for separating said two adjacent sections at the overlapping portion.

15. The liquid crystal display according to claim 10, characterized in that: a top surface or a bottom surface of the light guide plate composed of said sections is ladder-like while the other surface is flat so as to expose a side edge of each section.

16. The liquid crystal display according to claim 13, characterized in that: one of two adjacent sections of said sections of the light guide plate has a recess at the side edge for engaging with the other section, and a residual portion of said side edge is exposed.

17. The liquid crystal display according to claim 16, characterized in that: the exposed portion of said side edge reserves a thickness for defining a space to dispose the light source.

18. The liquid crystal display according to claim 10, characterized in that: said liquid crystal display further comprises a back plate, said back plate is formed as ladder-like for receiving said light guide plate and said light sources.
